(19) United States
(12) Patent Application Publication
(10) Pub. No.: US 2019/0130424 A1
(43) Pub. Date: May 2, 2019

(54) METHOD AND APPARATUS TO MEASURE SENTIMENT

(71) Applicant: CHANGE RESEARCH, PUBLIC BENEFIT CORPORATION, Palo Alto, CA (US)

(72) Inventors: Michael GREENFIELD, Palo Alto, CA (US); Jonathan GOLDMAN, Mountain View, CA (US); Benjamin GREENFIELD, Los Angeles, CA (US); Christopher COKE, San Francisco, CA (US); Lucia ZHENG, Tigard, OR (US); Brian LEUNG, Foster City, CA (US)

(73) Assignee: CHANGE RESEARCH, PUBLIC BENEFIT CORPORATION, Palo Alto, CA (US)

(21) Appl. No.: 16/172,579

(22) Filed: Oct. 26, 2018

Related U.S. Application Data
(60) Provisional application No. 62/579,681, filed on Oct. 31, 2017.

(51) Int. Cl. G06Q 30/02

(52) U.S. Cl. CPC G06Q 30/0201; G06Q 30/0261; G06Q 30/0205; G06Q 30/0203

(57) ABSTRACT

A system and method to provide a sentiment measurement system with automatic ad placement to collect surveys of voters is described. This enables a candidate to rapidly and easily measure voter sentiment at scale, quickly and cost-effectively while addressing technical limitations that normally prevent accurate use of traditional internet ad platforms for such purposes. Existing ad targeting is not designed for providing representative samples, thus the system can automatically target ads and regularly adjust based on incoming poll responses to ensure representative data is received. The system and method applies to other sentiment measurement, e.g. general opinion polling. Further, the system and method combines online micro-targeting with dynamic bias correction to produce appropriate sample groups.

### RELATED CASES

This is a non-provisional application of provisional application Ser. No. 62/579,681 by Greenfield et al., filed 31 Oct. 2017, entitled “Method and Apparatus to Measure Sentiment”.

### BACKGROUND

### Field

This disclosure is generally related to measuring sentiment. More specifically, this disclosure is related to providing automated tools for sampling the polity in a voting region using surveys.

### Related Art

Companies have conducted political polls using telephonic surveys for years. Before that the first “straw polls” were recorded in the US circa the 1820s. More recently, with the advent of the internet, some companies have turned to various types of internet-based polling. For example, some attempts have been made to use Amazon's Mechanical Turk as a platform for polling. These prior approaches are overall quite expensive, time consuming, and do not necessarily produce a representative sample. A new approach that better leverages internet platform advertising, including social networks and mobile applications, could reduce these costs if the technical challenges could be addressed.

### BRIEF DESCRIPTION OF THE FIGURES

FIG. 1 shows an architectural level schematic of a system in accordance with an embodiment.

FIG. 2 is a hybrid architectural level schematic and process flow diagram for sentiment measurement in accordance with an embodiment.

FIG. 3 is a process flow diagram for sentiment measurement according to one embodiment.

FIG. 4 shows portions of the sentiment measures produced by the system.

FIG. 5 shows a listing of code used in accordance with an embodiment.

FIG. 6 shows a listing of code used in accordance with an embodiment.

### DETAILED DESCRIPTION

### Overview

The discussion is organized as follows. First, an introduction describing some of the problems addressed by various embodiments will be presented, followed by an explanation of terminology that will be used throughout the discussion. Then, a high-level description of one embodiment will be discussed at an architectural level. Next, the details of algorithms used by some embodiments will be discussed. Lastly, various alternative embodiments are discussed.

Consider two candidates: Jane Doe running for US Senate, and John Brown running for a local Board of Supervisors. Both Doe and Brown want accurate information about the state of the race. Classic public polls are time-consuming and expensive (order of magnitude $20-40K for a survey of under 1,000 voters). A US Senate candidate like Jane Doe will consume a large part of their budget on a poll like this, and local candidates like John Brown cannot afford them. In the United States, the political parties will often help subsidize these costs only for their favored candidates.

What if Doe and Brown had another alternative? What if for $2-10K, a new approach could be used to survey relevant voters and measure their sentiments accurately? The new approach needs to be statistically valid and deliver comparable, or improved accuracy. This is a challenging technical problem because it is not enough to put a survey up on a website or deploy one to Mechanical Turk. An accurate measurement of voter sentiments on issues and candidates requires polling of respondents that are likely to vote, not just respond to a survey, across a range of demographic groupings that is representative of the voting area that needs to be surveyed.

Naïve use of internet advertising platforms is similarly ineffective. Specifically, current platforms are oriented towards finding small groups of people who will be most interested in ads, not reaching a broad cross-section of society. Precisely the opposite of what is needed for broad sentiment analysis and opinion polling. Current platforms are typically limited in their targeting based on key demographic segments. Further, even permitted segmentation such as “location,” turns out to be surprisingly inaccurate. Thus, one technical problem faced is how to leverage existing ad targeting mechanisms of internet platforms to enable more accurate sentiment measurement of voters.

We describe a system and various embodiments to provide a sentiment measurement system with automatic ad placement to collect surveys of voters. This system enables a candidate to rapidly and easily measure the sentiment of voters in their district. Additionally, the system's capabilities may have the effect of causing candidates to increase their outreach efforts because the ability to measure voter sentiment at scale, quickly and cost-effectively is now available.

### Terminology

Throughout this specification the following terms will be used:

Candidate: Will refer to an individual running for political office. However, the system can be used by organizations interested in measuring voter sentiments on a ballot measure or proposition. More generally, the system could be used in non-political contexts where demographically accurate sentiment measurement is required.

Election: Will refer to a particular political election for a candidate that is being polled, e.g. Jane Doe's US Senate race in November 2018. A single poll can in fact cover multiple elections for multiple candidates or ballot measures.

Poll and poll question: A poll will refer to a collection of poll questions being asked of respondents in a given time period, usually concerning the election of a candidate, key issues among the candidate's electorate, or the effectiveness of various messages the candidate might share. Most polls can be run quite quickly with polls covering broad districts occurring in as few as 12 hours (or sometimes within a few days) with the results being delivered to the candidate promptly thereafter. A typical poll might have 10-100 poll questions. Some of the poll questions will be used to validate that the respondent is a voter in the district or assess the voter's likelihood of voting. The final poll results indicating sentiment measures would typically be based only on likely, or registered, voters. In some embodiments, the poll will be terminated early (e.g. without showing all questions) if the respondent is not a voter in the district. Data from early-terminated polls are useful to the system for adjusting targeting of respondents.

Respondent: Will refer to both to someone to whom inducements to take polls is presented, e.g. ad viewers, and to someone who follows the inducement, e.g. clicks on the ad, and takes the survey.

Segment, or demographic segment: Will refer to a segment for which a given poll is aiming to obtain a representative sample of for sentiment measurement and analysis. Common segmentations in US political polling include: political party affiliation; gender; race and/or ethnicity; age (usually in groups); educational attainment; location and/or region (e.g. to ensure geographic distribution of respondents). Typically, independent data is available about segments, e.g. census data and similar commercial data. An example may illuminate the definition and the distinction between a segment and a poll question. We know that rural voters and urban voters have different opinions. For a statewide office poll, getting a representative sample that is well distributed geographically is important. In contrast, respondents preferred sports teams are interesting data, but not something to segment on in a typical political poll. In most cases, it is important to have representativeness across geographic, ethnic, gender, religious, age, political, professional, and educational lines in order to avoid a skewed sample that will. Demographic, political, and regional representativeness is important to survey accuracy. For example, if we know that rural voters and urban voters have different opinions, then surveying a disproportionate ratio of these groups will yield a biased result.

Sentiment measurement, or analysis: Refers to the aggregate opinion of voters who responded to the poll on a given issue, e.g. the survey results. For example, in a poll of a statewide election, the results for Jane Doe for US Senate among likely voters would be a sentiment measure. The term can also be used, based on context, to refer to the results of the poll collectively or to speak about a specific segment. Sentiment analysis refers to the analysis of the answers to the poll questions to arrive at the sentiment measurement, this would include the weightings applied to the raw poll data to arrive at the final sentiment measurements.

Voter: Will refer to an individual voter. In political polling terminology, some polls are conducted of registered voters, others are conducted of likely voters, and still others assess individual voters probabilistically. The system can support sentiment measurement of all three types and unless the distinction between types of voters is relevant, it will not be highlighted in the discussion. Additionally, the system can weight voters according to their likelihood of actually voting in the election. If the system is used for non-political surveying, voter can be understood to refer to qualified respondents, e.g. if you are trying to survey attorneys, voter would refer to respondents with bar admission.

### System Overview

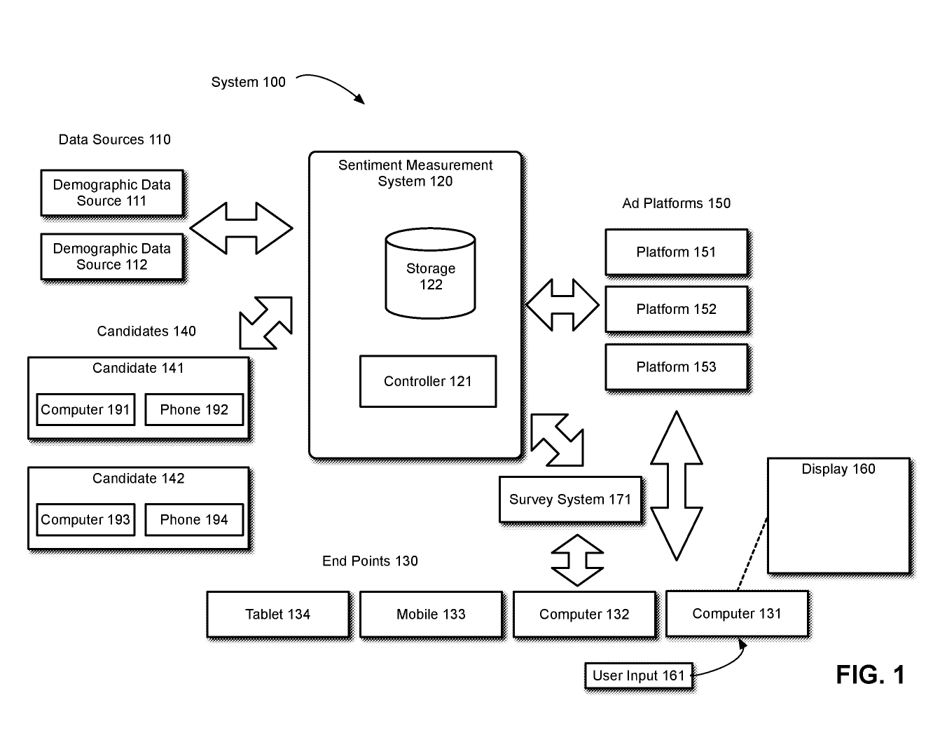

Processes and a system for sentiment measurement with automatic ad placement to collect surveys of voters is now described. The system will be described with reference to FIG. 1 showing an architectural level schematic of a system in accordance with an embodiment. Because FIG. 1 is an architectural diagram, certain details are intentionally omitted to improve the clarity of the description. The discussion of FIG. 1 will be organized as follows. First, the elements of the figure will be described, followed by their interconnections. Then, the use of the elements in the system will be described in greater detail.

FIG. 1 includes a system 100. The system includes data sources 110, sentiment measurement system 120, end points 130, candidates 140, ad platforms 150, and survey system 171. The data sources 110 include demographic data source 111 and demographic data source 112. The message management system 120 includes a controller 121 and storage 122. The end points 130 include computer 131, computer 132, mobile 133, and tablet 134. Computer 131 is coupled in communication with a display 160 showing a poll requested by the sentiment measurement system 120 in accordance with one embodiment. Additionally, user input 160 to the computer 131 is shown. The candidates 140 include two candidates: candidate 141 and candidate 142. Each candidate is shown with respective computers and phones (computer 191, phone 192, computer 193, and phone 194). The ad platforms 150 include platform 151, platform 152, and platform 153.

The interconnection of the elements of system 100 will now be described. The data sources 110 are coupled in communication to the sentiment measurement system 120 (indicated by double-headed line with arrows at end). The different sources may arrive via different mechanisms. For example, demographic data source 111 might be retrieved by SFTP while the demographic data source 112 might be retrieved via a web API, RPC calls, etc. All of the communications may be encrypted. The candidates 140 devices (phones and computers) are coupled in communication with the sentiment measurement system 120 (indicated by double-headed line with arrows at end). This allows the candidates 140 to request new polls, review previously requested polls, and conduct other administrative actions. The sentiment measurement system 120 is coupled in communication with ad platforms 150 (indicated by double-headed line with arrows at end). Each of the ad platforms may correspond to a social media service (e.g. Facebook, Snapchat, etc.), a specific web or application platform (e.g. Google, LinkedIn, Apple News, etc.), an aggregator (e.g. Doubleclick, etc.), or other place where advertisements can be placed. The sentiment measurement system 120 can access the ad platforms via a variety of APIs as appropriate for each platform. The ad platforms 150 are coupled in communication (indicated by double-headed line with arrows at end) with the end points 130 which are used by respondents to access the web sites and/or applications containing ads served by the platform. Lastly, the survey system 171 is coupled in communication with both the sentiment measurement system 120 and the end points 130 (both indicated by double-headed lines with arrows at end).

The use of the elements in the system will now be described in greater detail. Controller 121 and storage 122 can be composed of one or more computers and computer systems coupled in communication with one another. They can also be one or more virtual computing and/or storage resources. For example, controller 121 may be an Amazon EC2 instance and the storage 122 an Amazon S3 storage. Other computing-as-service platforms such as Force.com from Salesforce, Rackspace, Heroku, Google Compute Engine, Microsoft Azure, and others could be used rather than implementing the sentiment measurement system 120 on direct physical computers, or traditional virtual machines. Communications between the potentially geographically distributed computing and storage resources comprising the sentiment measurement system 120 are not shown.

The end points 130 are not in this embodiment coupled in communication to the sentiment measurement system 120; however, the survey system 171 could be directly implemented by the sentiment measurement system. In the shown embodiment, the survey system 171 is a commercial survey tool, e.g. SurveyMonkey, Qualtrics, or similar. It might also be a proprietary system. Communications between the end points 130, the ad platforms 150, and the survey system 171 is generally over a network such as the internet, inclusive of the mobile internet via protocols such as EDGE, 3G, 4G, LTE, Wi-Fi, and Wi-Max. The other communications shown in FIG. 1 are generally over the internet and/or private networks. Direct communication with the end points 130 is not necessary because existing advertising technology and deployment mechanisms of the ad platforms are used. For example, if platform 151 is Facebook, then the Facebook application for iOS, or Android, running on mobile 133 is already capable of displaying the advertisement. Similarly, if a user activates the advertisement, the displayed survey can be handled in application, in a web browser, or dedicated survey application provided by the survey system 171.

The mobile 133 can be any mobile device with suitable data capabilities and a user interface, e.g. iPhone, Android phone, Windows phone, Blackberry. The tablet 134 can be any tablet computing device, e.g. iPad, iPod Touch, Android tablet, Blackberry tablet. Although not shown in FIG. 1, TVs could similarly be used such as a TV with built in web support, for example Boxee, Plex or Google TV built in, or can be a TV in conjunction with an additional device (not shown and often referred to as a set-top box) such as a Google TV, Boxee, Plex, Apple TV, or the like. The computers 131 and 132 are general purpose computers, e.g. Macintoshes, Wintel PCs, Chromebooks, etc. For computer 131, the display 160 is coupled in communication with the computer 131 and the computer 131 is capable of receiving user input 161, e.g. via keyboard, mouse, track-pad, touch gestures (optionally on display 160).

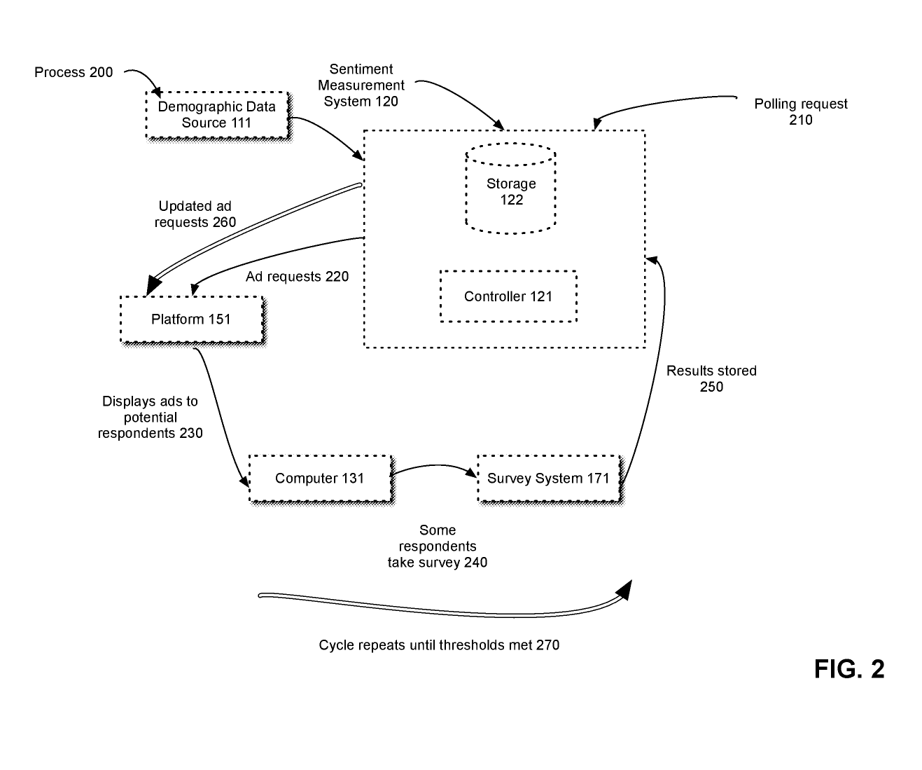

Having described the elements of FIG. 1 and their interconnections, the system will be described in greater detail in conjunction with FIG. 2, showing a hybrid architectural level schematic and process flow diagram for sentiment measurement in accordance with an embodiment.

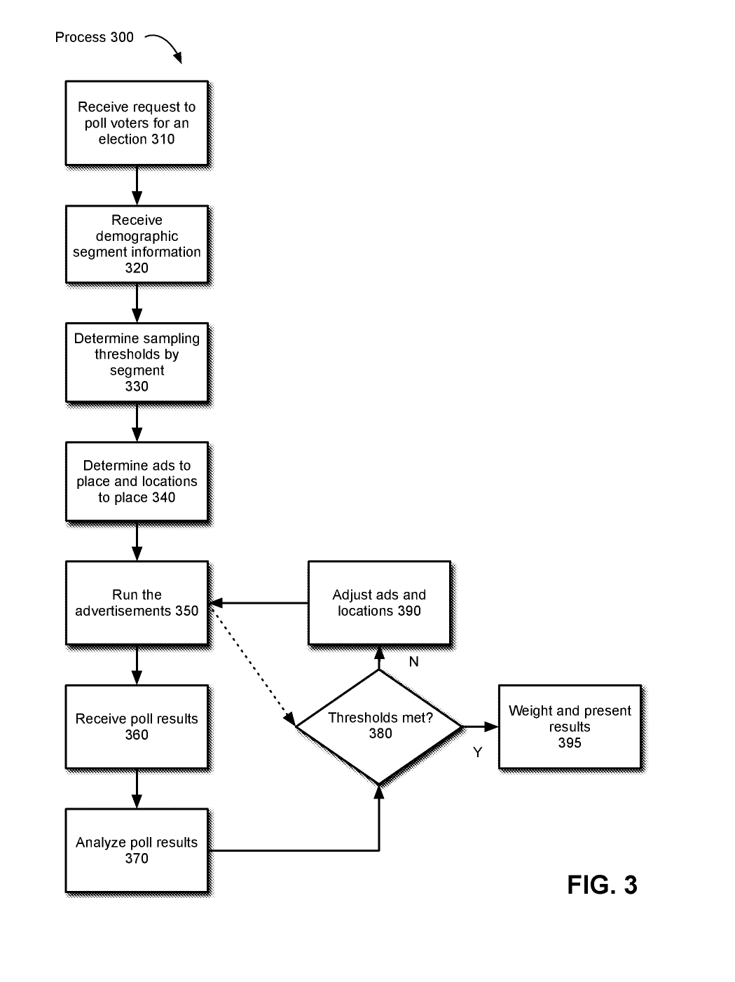

In FIG. 2, some of the structural elements of FIG. 1 are shown with dotted lines to put the emphasis on the primary data flows of the overall process used by some embodiments. The process itself will be described in greater detail in conjunction with FIG. 3; however, this view is instructive for providing a high-level outline. This discussion will also help highlight some of the technical problems of bias correction found in using general purpose ad platforms.

FIG. 2 shows the following elements from FIG. 1 with dotted lines for context: sentiment measurement system 120 (with controller 121 and storage 122), demographic data source 111, platform 151, computer 131, and survey system 171.

Process 200 of FIG. 2 starts with a polling request 210. For example, candidate 141 (not shown) may be interested in how her US Senate race is looking. She can submit that request using any of her devices, e.g. computer 191. In some embodiments, it may be possible for her to check the status of the poll and see partial results in real time. In other embodiments, notifications may be sent to her devices, including phone 192, to update her on the status of the polling.

In some embodiments, the candidate 141 can simply select the race she wishes to poll from a picker-type interface presented on computer 191, e.g. a web form pre-populated by the sentiment measurement system 120 with known upcoming races/ballot measures. In some embodiments, the candidate may have the opportunity to customize polling questions or remove and add questions from a predefined library. The range of questions that the candidate 141 can adjust may be limited to ensure that necessary demographic segmentation information is received, e.g. candidate might be prevented from removing gender question by default. In some embodiments, the candidate may be prompted to pay for the poll at this juncture (or at least preauthorize a credit card). In other embodiments, the candidate may be afforded the opportunity to upload a targeting list, discussed further below. However, in the normal course, the candidate simply needs to select the election they want polled and leave it to the system 120 to carry out the polling.

Bias correction is an important component of the system 120 to ensure that accurate results that match the appropriate electorate's demographics are provided. The starting point is to obtain accurate demographic data, in this point the data comes from demographic data source 111, e.g. census data. For this example, we will focus on race/ethnicity alone (though gender, race/ethnicity, educational attainment and more can be simultaneously surveyed and bias corrected). In this case, the district is 18% black.

Before any ad requests 220 are sent to platform 151, e.g. Facebook alone in this example, the available ad segments and their prior demographic properties are consulted. For example, if care is not taken in selecting ad segments it may be challenging to reach a sufficient number of black voters in the district. Further, Facebook (and other ad platforms) often do not allow direct targeting on these key factors. Sometimes they allow targeting on characteristics similar to these factors, but that targeting may only be 50% accurate. Further, even when the platform appears to allow accurate targeting (e.g. location), in practical terms the actual poll responses received in testing indicate there are significant targeting errors. Overcoming this technical limitation of ad platforms 150 is important to providing a successful poll. The weighting and selection of ad segments will be discussed in greater detail in conjunction with FIG. 3.

Once the ad requests 220 are sent to the platform 151, at least for a time, things are out of the hands of the sentiment measurement system 120. In practice, the system 120 can periodically check on its ad spend and adjust the ad request segments if polls are not being answered.

The platform 151 is responsible for displaying ads to potential respondents 230. For example, Facebook presents ads in the newsfeed on mobile as well as in the sidebar on computers. The ads are selected for presentment by the platform based on bidding. Thus, when the ad request 220 was submitted, the sentiment management system placed a maximum bid for a given ad segment, e.g. Facebook has “Behaviors>Multicultural Affinity>African American (US).” Keep in mind the technical problem: this ad targeting will not, in practice, return anything close to 100% black voters. Thus, the sentiment management system will need to adjust for this error to produce a valid sentiment measurement (see discussion of FIG. 3 below).

If the user clicks through the ad, then from the computer 131 the computer's web browser would be redirected to a web survey (some respondents take survey 240) that is managed by the survey system 171. The results of those surveys get provided to the sentiment measurement system 120 (results stored 240). (The approach is analogous for tablets and mobiles.)

At this point, the bias correction approach needs to kick in. It typically would be after a number of poll responses come in, but the ad segments being targeted and even the ads themselves can be updated (updated ad requests 260) and the broader cycle will repeat until thresholds for the overall sample, and demographic segment samples, have been met (cycle repeats 270) moving through steps 230, 240, 250, and 260 as needed. For example, after getting 50 of approximately 500 polls sought for candidate 141, the results may indicate that blacks are heavily underrepresented, and worse that the segment targeting blacks is actually producing more Hispanic voters than black voters. Thus, the updated ads may be shifted to different segments to improve the probability that our poll gets black representation closer to the 18% for the district.

Once the thresholds are met, the ads can be pulled from the platform 151 and the results tabulated and weighted/post-stratified to better reflect the demographics of the district. In this example, the candidate 141 is able to review the poll requests on her phone 192 the next morning and upon seeing her position plus reactions to a custom question she asked about her planned slogans decides to go with the slogan that resonated most positively with voters in her district.

Process Details

Having provided an overview of the approach, the process used by embodiments of the sentiment measurement system 120 will be explored in greater detail in conjunction with FIG. 3 which is a process flow diagram for sentiment measurement according to one embodiment.

FIG. 3 includes process 300 which starts at step 310, with receipt of a request to poll voters for an election. As discussed, above, in conjunction with FIG. 2, this can be a self-service internet, or application, portal that allows a candidate to select the election to poll for and select the polling questions. An example set of polling questions with groupings for a statewide election is shown:
Demographics and qualification of respondent
   Gender
   Race/ethnicity
   Age
   Educational attainment
   Political party identification
   Income
   Location (e.g. zip code)
   Plan to vote in upcoming election
Candidate preferences and voting practices
   Voted in primary?
   Preferred candidate for selected race, e.g. US Senate
   Preferred candidate for an additional race(s), e.g. down ballot races
   Prior votes, e.g. 2016 president
   Prior votes, e.g. prior vote in senate race
   Prior votes, e.g. primary votes
   Current preference, e.g. rechecking how they might vote for president today
General Context
   Sources of news
   Approval ratings, e.g. president, current incumbent, etc.
   State of economy
   Most important factors in voting for race
   Most important issues facing the district
   Views on the interface between current election and other bodies, e.g. governor vs. president, local vs. state, etc.
Specific issues
   Polling on specific issues, e.g. affordable care act
   Custom positions, e.g. slogans, positions and similar of the candidate

The above questions are by n means exhaustive; however, providing access to a library of question designs for a candidate where a valid sentiment measurement can be taken without the need for expert survey design is important.

At step 310, the sentiment measurement system 120 can optionally collect payment, or payment authorization. For example, from the phone 192 of candidate 141, Apple Pay or Google Wallet could be used to easily collect payment for the survey. In other embodiments, payment is handled outside of process 300, e.g. with traditional invoicing.

With the poll questions defined and election selected, the sentiment measurement system 120 proceeds to receive demographic segment information (step 320). In some embodiments, multiple data sources 110 are integrated to estimate the demographics of the election district. In one embodiment, demographic data source 111 is data from a census, e.g. US Census Bureau, while demographic data source 112 is a private data source, e.g. Catalist or Target Smart. In this example, controller 121 can hide these details by providing a call to actual_demographics(district, demographic_type). Which returns the relevant information, e.g. gender: 53% women, 47% men; race/ethnicity: 19% black, 6% Hispanic, 3% Asian, and 67% white, etc.

At step 330, the sample sizes and sampling thresholds by segment can be determined. Within each segment, the system seeks a sample roughly equal to the expected total sample size, times the percentage of the overall population in that district. For instance, if the segment consists of black females over age 50, who represent 4.5% of the population of the district, and the target sample size is 1000, the system will seek to have approximately 45 respondents (1000*4.5%). The thresholds provide guidance to the repeating portions of process 300 (see steps 350, 360, 370, 380, and 390) which allow for bias correction as respondents complete the poll.

At step 340, the ads to place and locations are determined. By locations, we are referring to platforms for ad placements (e.g. ad platforms 150). Note, steps 340 and the later discussed step 390 are substantially identical, but are shown separately to emphasize the distinction between the first establishment of ads, platform locations, and targeting vs. the adjustments for bias correction. For example, if platform 151 is Facebook and platform 152 is Google AdWords, a mix of platforms may be used. For simplicity of discussion, the remainder of this example will focus on ads placed on a single platform; however, the capability to support multiple platforms simultaneously as well as different platforms is important. In the US, Facebook currently has strong penetration across the population; however, outside the US, the penetration of Facebook may be lower while another region-specific platform, e.g. platform 153, may be a more appropriate place to seek respondents. The ad copy (including imagery if needed) itself is generated at this point. In some embodiments, the ad copy is automatically generated by the sentiment measurement system 120. In other embodiments, a more or less “stock” set of ad copy with some templatized modification support is used to encourage respondents viewing the ads to complete the survey, e.g. customizing the ad for the specific election and/or demographic target. Similarly, the graphics can be either templatized or customized, e.g. a picture of a black person with an exhortation to “Make your voice count, tell us what you think” may induce more black people to complete the survey.

Step 340 (and later step 390) is tasked with overcoming a key technical limitation, the inability of current ad platforms 150 to accurately target demographic segments. Some of these limits are intentional, e.g. for various reasons platform operators like Facebook may not want to allow explicit targeting by some of the demographic segments, e.g. race/ethnicity. However, even for segments like location, experience shows that the platforms do not accurately identify respondents who are voters in the district correctly. Thus, for a given ad segment, the sentiment measurement system tracks prior results, e.g. expected_weightings_for_audience(segment, demographic_type).

Thus, calling this function for a segment like “Hispanics between 18 and 34” with the demographic type ethnicity might return a prediction of 59% Hispanic, 34% white, 4% black, 3% Asian. Note, in some embodiments the functions track ad platform specific data so an additional parameter to the function call would be the platform.

At this stage within step 340, the accuracy_importance(demographic_type) can be used to assess the importance of getting a given demographic type right. The values should sum to 1. Thus, if age was set to 0.9, the remaining demographic segments could only sum to 0.1. This would indicate that you want to focus on age; however, all of the factors could be set equally. In some embodiments, the candidate may be able to adjust these accuracy importance values as part of step 310.

So continuing within step 340, an ad audience is constructed that will (a) reach the district (location) and (b) poll respondents that are as close as possible to the demographics from actual_demographics(district, demographic_type)adjusted for the weightings. This can be viewed as an array of possible_ads[0] . . . possible_ads[n]. These are paired with the ad_dollar_weighting[0] . . . ad_dollar_weighting[n], which need to be computed to minimize the expected squared error across demographics weighted by the accuracy importance values. (Again, these could be split across ad platforms 150 but for the simpler case we will put all of them on a single platform, e.g. platform 151.)

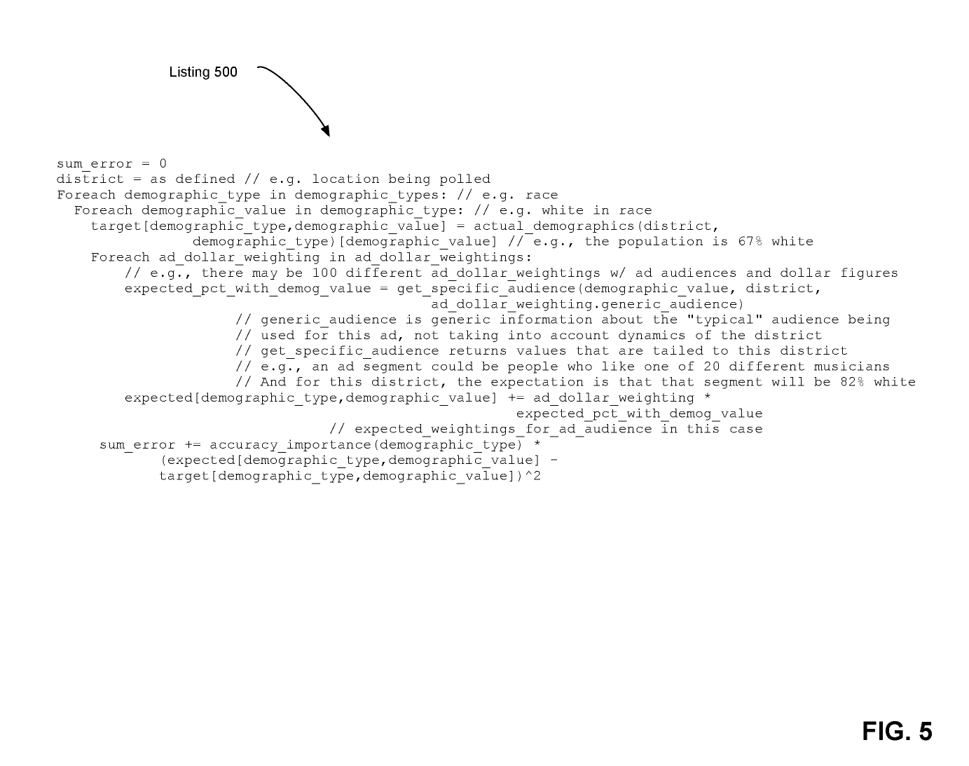

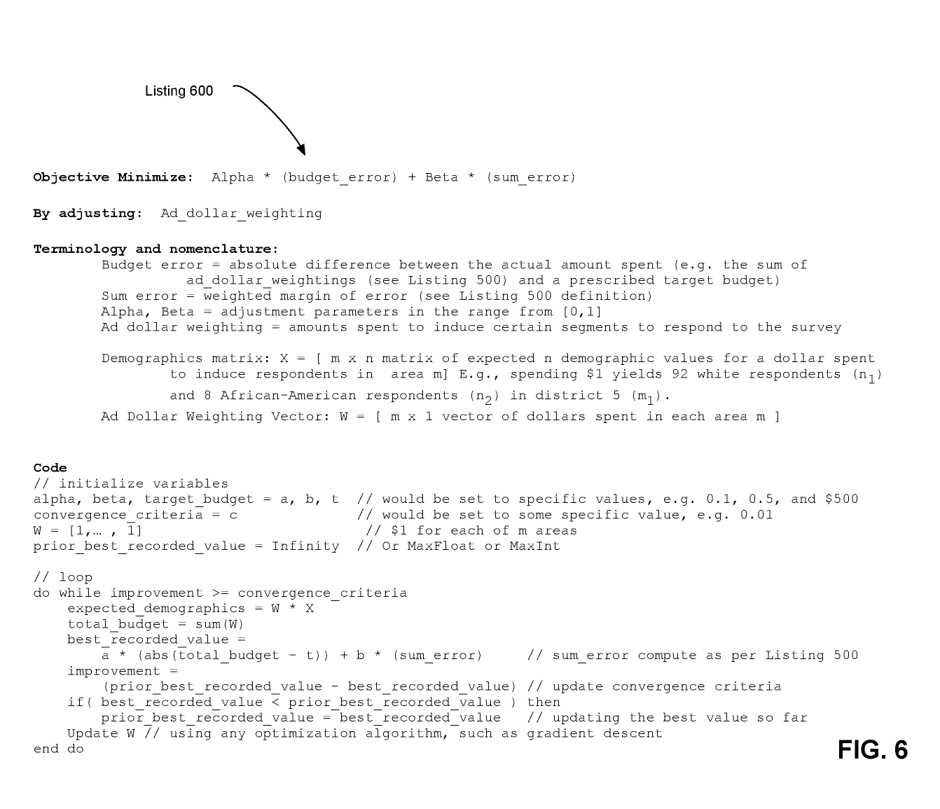

This is summarized in listing 500 of FIG. 5 which shows pseudocode for implementing this computation. Listing 500 alone is insufficient, what further occurs at step 340 is to simulate multiple permutations of ad_dollar_weighting arrays to select the array that produces the smallest sum_error according to the approach of listing 500. In some embodiments thousands, or more, permutations are attempted. Note that listing 500 is one approach to estimating errors, other approaches for estimating the expected error and adjusting ad targeting can be used, e.g. listing 600 of FIG. 6 could be used either instead or in conjunction with listing 500. (Note that as presented, listing 600 assumes some of the definitions and approaches of listing 500).

Next at step 350, the sentiment measurement system starts running ads with the ad platforms 150. The ads encourage potential respondents to take the survey. This is shown at step 360 where poll results start coming into the sentiment measurement system 120. These are analyzed to check whether the targeting is working. E.g., did targeting “Hispanics 18-34” actually produce an audience that is 59% Hispanic?

Steps 370 and 380 highlight this analysis and the potential to either stop (have enough samples in which case the process moves from step 380 to step 395) or adjust the ads and locations at step 390. As mentioned, step 390 is substantially the same as step 340; however, we now have adjusted data for expected_weightings_for_ad_audience. Using a Bayesian process, we can take the priors which average to the initial value (59% in this example), but update with the actual data. This allows continuous updates of the targeting to minimize expected deviation from the desired sample. The dotted line from step 350 to step 380 also highlights the potentially continuous updates that are possible, e.g. if no responses are coming in the ad targeting can be adjusted as well.

Additionally, in step 390 the target can be updated. The target is initially the percentage of people meeting a criterion in the population. But as responses are received, the target should adjust to reflect the remaining responses sought. For example, if we are looking to get 19% black respondents out of 1000 respondents being surveyed, but the first 500 responses only include 10% black respondents (50 people), we will want the remaining 500 respondents to get another 140 black respondents (19% total). That means our target for the last 500 respondents will be 28% black.

Thus, the target changes over time. The initial target, t₀, should match the election district generally unless a special purpose sentiment measurement is being conducted. But at the first resampling and adjustment in step 390, a new target, t₁, can be set. Thus, using the example just above the original target t₀=19% black, but t₁=28% black.

Returning briefly to step 380, thresholds are tested and ads can be stopped at this stage. For example, the goal was to sample 1000 likely voters and we have received surveys from 1000 likely voters, the survey can be stopped. In the case that we have not obtained sufficient responses for segments, the system can opt to accept the current sample or to continue polling to focus on the missing segments. This decision may be based on a number of factors, for example the amount of undersampling. For example, going back to targeting 19% black respondents, it may be acceptable to have a sample that is 18% black but unacceptable to have a sample that is 5% black. Thus, in one embodiment, the decision about whether to accept the results is based on predetermined thresholds of the amount of error allowed across the target groups. In other embodiments, the total budget for the survey may control, e.g. if the candidate only authorized $2K maximum for ad spend and that has been used, the system might stop despite the error exceeding the allowed amount.

In one embodiment, the adjustments from steps 370, 380 and 390 only occur every 5-10%. E.g. if the goal is to sample approximately 1000 respondents, adjustments would only occur every 50-100 poll responses.

Once the threshold(s) for the number of poll responses are met at step 380, the process 300 can terminate and at step 395 with the results weighted (stratified) and presented to the user thus presenting the sentiment measurements, see next section below for more detail. Post-stratification is essentially complementary and independent of bias correction. Bias correction happens on the ad side and post-stratification after the fact.

In some cases, it is valuable to reach people only from a specific list. For instance, a Democratic candidate in a district might want to poll people who have voted in previous Democratic primaries. In this instance, rather than targeting by location, a list of names and other characteristics like ZIP code and phone number will be uploaded and matched with an ad platform's database. In this case, targeting and adjustments will work analogously to the manner described above for location-based targeting once the initial sample of respondents is defined. Note again, based on experience, the ad targeting does not guarantee 100% sample accuracy.

Location and Circle Fitting

Embodiments may need to deal with imprecision in the location targeting capabilities of the underlying platform. As such, some embodiments make use of circle fitting to more precisely target geographic regions using a combination of latitude, longitude, and bounding radius data points. The approach can return a string with the sequence of data points that are meant to be used with an ad engine for “coordinates”. In one embodiment, the result is a spreadsheet for Facebook Ad Manager that can be uploaded through the Facebook Ads API, to target audiences by the bulk sequence of data points specified. At present this level of granularity is not possible directly in the Facebook Ad Manager user interface.

Imagine if the platform 151 only supports the following geographic layers for targeting: country, state/region, city, designated market area, zip/postal code, or business address. However, the platform 151 may also allow targeting by a combination of latitude, longitude, and a bounding radius specification (imagine a point and a circle around it, hence the name circle fitting).

Congressional districts and state legislative districts often are not easily specified using the default geographic layers. Thus, instead circle fitting can be used to approximate legislative district shapes. This produces more accurate targeting because the radii on the circles can be assigned small values that can vary.

One embodiment was implemented in the R language using the shapefiles that are collected from public records (e.g. census) which reflect the most recent congressional and state legislative district shapes. The approach then finds the correct EPS G projection that “flattens” the shapefile from latitude longitude data to a 2D plane to prepare for circle fitting and retrieves the bounds of the shapefile. One embodiment sweeps the 2D plane to test x-coordinate/y-coordinate/bounding radii in feet (represented as circular spatial polygons in R) on the shapefile. Circles with a specific percentage of overlap with the shapefile area (predetermined at run time), and with limited overlap with its established neighboring circles, are retained as “good fits” and retained. If a circle fails to be a “good fit” under these criteria, the algorithm simply moves on to the next x-coordinate/y-coordinate/bounding radius in feet. When the 2D plane is filled with “good fit” circles across the bounding area, the algorithm converts the retained points back to latitude/longitude/bounding radius and formats each set into a format appropriate for platform 151. Often, that format is a string which can be joined with all the other sets (for other districts/census tracts that combine to make a district) as a semi-colon delimited list for use in the platform 151. This approach solves the technical problem of needing to accurately target location in a system that does not directly support legislative districts.

Reviewing Results

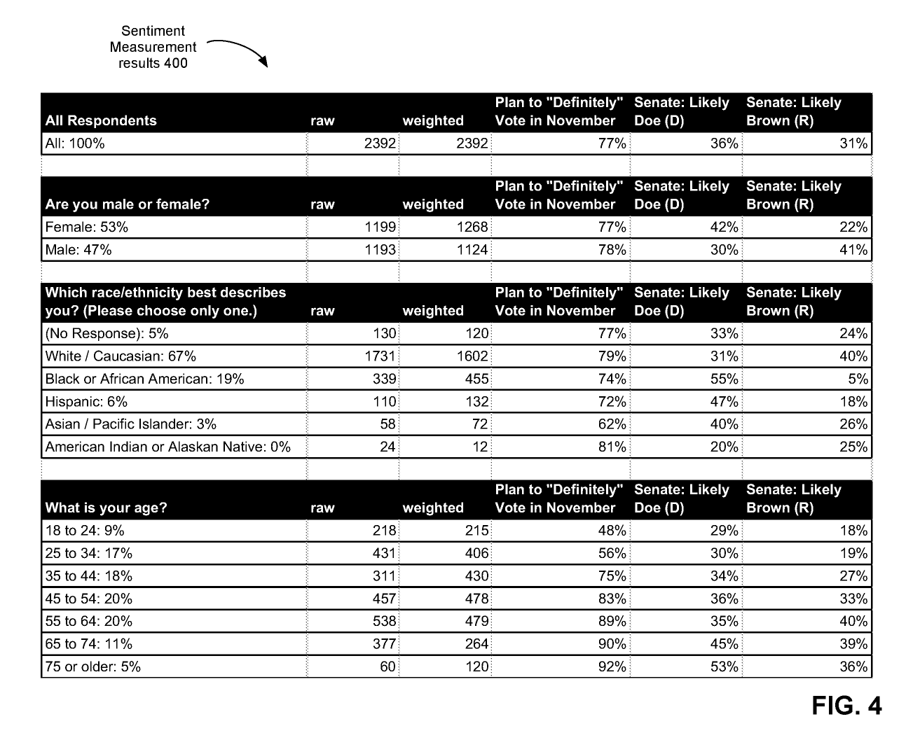

FIG. 4 shows portions of the sentiment measures produced by the sentiment measurement system 120 specifically a number of sentiment measurement results 400 are shown.

This example is presented in a fairly static, tabular format. However, more dynamic and graphical representations can be used. For example, the results can be presented using a Pivot-table like approach of permitting the candidate, or their staff, using computers 191 and 193 or phone 192 and 194, to drag-and-drop select poll questions and demographic segments to view the data according to custom views.

In the sentiment measurement results 400, the following basic approach was used. Each poll question (and the summary) is a block with the appropriate segments. Taking the second large grouping which is the gender question, the options are shown together with the overall split of the weighted poll results (e.g. “Female: 53%”) together with the raw and weighted data. In this case, candidate Doe has requested to see those values split along their voting intention and which of Doe and Brown the voter is favoring. Reading across the Female line, there were 1199 raw responses (of 2392 poll responses) from respondents indicating they were female. After the weighting, that is 1268 responses. Of those responses, 77% plan to “Definitely” vote in November and 42% likely will vote for Doe while 22% are likely to vote for Brown.

### Additional Embodiments

We have now described a system and processes that afford an easy way to provide a sentiment measurement with automatic ad placement to collect surveys of voters. The system and method applies to other sentiment measurement, e.g. general opinion polling. Further, the system and method combines online micro-targeting with dynamic bias correction to produce appropriate sample groups. Micro-targeting in this case is referring to the nature of online ad placement systems which as discussed, above, usually are oriented towards finding small groups of people who will be most interested in ads, not reaching a broad cross-section of society. This is the opposite of what is needed for broad sentiment analysis. Thus, being able to leverage the existing micro-targeting of online platforms with the dynamic bias correction discussed, above, can be used to produce valid public opinion polls and sentiment analysis.

Some embodiments perform additional polling of voters before and after an election to gauge likelihood of voting and incorporate that into the analysis on a go forward basis. For example, by running surveys just before and after election day it is possible to see how people answer poll questions about voting and compare that with their self-reported behavior after election day. From that, the system can build predictive models based on answers to poll questions. This is important for candidates want to know who is going to vote vs. not and to focus their messages on people who will vote. This in turn provides a much finer grained sense of the voting population for a given district.

As discussed, above, embodiments attempt to get appropriately representative samples of the district across demographic segments. But this may require that the system differentially bid for certain segments. Some embodiments track the margin of error and thresholds (see FIG. 3 discussion) for a poll given the weightings. The error will be higher if a group is under-sampled and has to be upweighted. Thus, embodiments can compute the change to the margin of error for additional respondents in different demographic segments. The system might evaluate the (change in margin of error) vs. (cost of getting respondent) and attempt to get additional respondents to maximize the ratio. This is an alternative, or compliment, to the approach in FIG. 3. For example, if so far 500 respondents have been polled, but it was expected that 20% would be in segment X, but only 4% of respondents so far are in group X, how might that change the system's behavior. If not corrected, then the 4% in group X are having their responses over weighted and that negatively impacts the margin of error. The system can compute the marginal value of an additional respondent in group X. It changes as the polling progresses. This may translate into the system being willing to bid/pay more, e.g. $0.10 to reach most respondents, but be willing to pay $0.50 to reach a group X respondent now. That willingness to overpay will decrease as the number of respondents in group X increases towards the expected target.

Some additional embodiments and features include:
Some embodiments support much larger polls (e.g. 10K+ respondents) with:
   A/B testing of question texts
   More detailed cross-demographic analysis
Other embodiments may be used to more regularly poll on breaking news, e.g. perhaps even the media/press might run polls
Other embodiments may be used to test the effectiveness of candidate's social media ads via experimentation, e.g. during the poll, proposed candidate ads could be shown for polling. This could also be used to A/B test messages with different respondents being shown different ads to test effectiveness.
Some embodiments using Facebook in particular (or other similar platforms) could be used to experiment by dividing respondents into several groups and surveying by group. So, in this case different actual ads would be run for each group. The survey could be done after the ad is known to have been served to test response to the ads.
The system is capable in some embodiments to run fully autonomously with no human intervention after the candidate requests the poll. This enables internet-scale polling in a way that traditional polling is hampered by the need for expertise in poll question design and poll management. In some embodiments, the system has an intake process for candidates where they are taken through an automated interview of questions (e.g. like a computer “wizard”) to construct the poll. The poll is then constructed automatically based on the interview and pushed out automatically (e.g. process 300).
Some embodiments poll across multiple platforms simultaneously. The embodiments described focused on mobile/web ad platforms. However, messaging/chat services can be used as well as SMS. Multiple platforms can be combined simultaneously.
In one embodiment, SMS-based polling is combined with the approach described above to check for biases in one or the other samples.
Outside of politics, this system can be used more broadly by companies, the press/media, advocacy groups and similar.
   For example, the press often wants to discuss public sentiment, but the costs and timing are currently prohibitive. This system enables more cost-effective polling they could quickly and reliably use in a timeframe more appropriate for a typical news story.
   Advocacy groups could now commission polls to use in discussions with legislators to help specific legislators understand how their votes would influence voters.
   Companies could use this tool for sentiment measurement around public relations issues and similar.
Some embodiments have advanced visualization tools for the results. For example, the results might be made available as static downloadable tables/graphs, e.g. Excel or PowerPoint. But also, as interactive graphs and tables (pivot tables). In other embodiments, integration with business intelligence tools (Tableau, QlikSense, Microsoft Power BI, Tibco Spotfire, Sisense BI, etc.). Still other embodiments may support automated identification of insights from the data.
Candidates can respond to the results in a number of ways. For example, adjusting their advertising, increasing direct outreach efforts to groups most likely to be persuaded, clarify their positions. Embodiments supporting AB testing of messaging can help candidates test various messages ahead of their use on the campaign trail.

### CONCLUSION

Any data structures and code described or referenced, above, are stored according to many embodiments on computer-readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed. Several of the computer-readable storage medium are non-transitory.

The preceding description is presented to enable the making and use of the invention. Various modifications to the disclosed embodiments will be apparent, and the general principles defined herein may be applied to other embodiments and applications without departing from the spirit and scope of the invention. Thus, the invention is not intended to be limited to the embodiments shown, but is to be accorded the widest scope consistent with the principles and features disclosed herein. The scope of the invention is defined by the appended claims.

What is claimed is:

1. A computer-implemented method for sentiment measurement, the method comprising:
receiving, at a computer, a request to poll voters for one of (i) an election and (ii) gauging opinion on one or more topics;
receiving, at the computer, a plurality of demographic segment information for the election, each demographic segment corresponding to information about the composition of one of (i) voters in the district and (ii) residents of the district;
determining, using the computer, a sampling threshold for the poll and a plurality of sampling targets for each demographic segment;
determining, using the computer, a plurality of advertisements to place on a plurality of internet advertising locations,
wherein each advertisement of the plurality of advertisements targeted at a plurality of respondents to encourage them to complete a poll, and
wherein each advertisement targeted at least one demographic segment identified from the plurality of demographic segment information;
running the plurality of advertisements on the plurality of internet advertising locations;
receiving, at the computer, poll responses, each poll response from a respondent and related at least one advertisements in the plurality of advertisements;
analyzing, using the computer, the poll responses to determine whether the poll responses are providing demographically representative data across the plurality of demographic segment information in view of the plurality of sampling targets for each demographic segment;
adjusting, using the computer, the sampling targets for the plurality of demographic segments and the plurality of advertisements view of the analyzing and running the plurality of advertisements as adjusted;
while the number of poll responses is less than the sampling threshold for the poll: regularly repeating analyzing and adjusting while continuing the receiving of poll responses.

2. The method of claim 1, wherein the plurality of internet advertising locations selected from a set comprising an advertising exchange, a social networking platform, a search engine, and an internet site.

3. The method of claim 1, wherein the plurality of internet advertising locations comprises one of Facebook Ads, Google AdWords, Snapchat Ads, Instagram Ads, Pinterest Ads, and Amazon Ads.

4. The method of claim 1, wherein at least one of the plurality of advertisements selected from a set comprising a display ad, a text ad, a video ad, and a native ad.

5. The method of claim 1, wherein there is an accuracy importance vector, the accuracy importance vector having values describing the relative importance of reaching the desired target for a demographic segment being targeted.

6. The method of claim 5, wherein the determining and the adjusting comprise:
computing a plurality of sums of the difference in expectation less target squared as weighted by the accuracy importance vector on the given internet advertising location for a plurality of potential ad purchases; and
selecting one of the plurality of potential ad purchases having the lowest sum in the plurality of sums.

7. A system comprising:
a storage,
a network interface, and
a computer system, the computer system coupled in communication with the network interface and the storage, the computer system including a controller to:
receive a request to poll voters for an election;
receive a plurality of demographic segment information for the election, each demographic segment corresponding to information about the composition of one of (i) voters in the district and (ii) residents of the district;
determine a sampling threshold for the poll and a plurality of sampling targets for each demographic segment;
determine a plurality of advertisements to place on a plurality of internet advertising locations,
wherein each advertisement of the plurality of advertisements targeted at a plurality of respondents to encourage them to complete a poll, and
wherein each advertisement targeted at least one demographic segment identified from the plurality of demographic segment information;
running the plurality of advertisements on the plurality of internet advertising locations;
receive poll responses, each poll response from a respondent and related at least one advertisements in the plurality of advertisements;
analyze the poll responses to determine whether the poll responses are providing demographically representative data across the plurality of demographic segment information in view of the plurality of sampling targets for each demographic segment;
adjust the sampling targets for the plurality of demographic segments and the plurality of advertisements view of the analyzing and running the plurality of advertisements as adjusted;
while the number of poll responses is less than the sampling threshold for the poll: regularly repeat the analysis and adjustments while continuing the receipt of poll responses.

8. The system of claim 7, wherein the plurality of internet advertising locations selected from a set comprising an advertising exchange, a social networking platform, a search engine, and an internet site.

9. The system of claim 7, wherein the plurality of internet advertising locations comprises one of Facebook Ads, Google AdWords, Snapchat Ads, Instagram Ads, Pinterest Ads, and Amazon Ads.

10. The system of claim 7, wherein at least one of the plurality of advertisements selected from a set comprising a display ad, a text ad, a video ad, and a native ad.

11. The system of claim 7, wherein there is an accuracy importance vector, the accuracy importance vector having values describing the relative importance of reaching the desired target for a demographic segment being targeted.

12. The system of claim 11, wherein the determine and the adjust comprise:
compute a plurality of sums of the difference in expectation less target squared as weighted by the accuracy importance vector on the given internet advertising location for a plurality of potential ad purchases; and
select one of the plurality of potential ad purchases having the lowest sum in the plurality of sums.

13. An apparatus for sentiment measurement, the apparatus comprising:
means for receiving a request to poll voters for an election;
means for receiving a plurality of demographic segment information for the election, each demographic segment corresponding to information about the composition of one of (i) voters in the district and (ii) residents of the district;
means for determining a sampling threshold for the poll and a plurality of sampling targets for each demographic segment;
means for determining a plurality of advertisements to place on a plurality of internet advertising locations,
wherein each advertisement of the plurality of advertisements targeted at a plurality of respondents to encourage them to complete a poll, and
wherein each advertisement targeted at least one demographic segment identified from the plurality of demographic segment information;
running the plurality of advertisements on the plurality of internet advertising locations;
means for receiving poll responses, each poll response from a respondent and related at least one advertisements in the plurality of advertisements;
means for analyzing the poll responses to determine whether the poll responses are providing demographically representative data across the plurality of demographic segment information in view of the plurality of sampling targets for each demographic segment;
means for adjusting the sampling targets for the plurality of demographic segments and the plurality of advertisements view of the analyzing and running the plurality of advertisements as adjusted;
while the number of poll responses is less than the sampling threshold for the poll: means for regularly repeating analyzing and adjusting while continuing the receiving of poll responses.

14. A computer-implemented method for generating an advertising purchase for an internet advertising location to produce a representative sample across a plurality of demographics, the method comprising:
obtaining, at a computer, an identification of an election district being polled;
obtaining, using the computer, a plurality of data about demographic values for the plurality of demographics in the district;
simulating, using the computer, a plurality of ad dollar weightings, each ad dollar weighting representing a proposed purchase of advertisements to reach a representative sample of respondents in the election district;
selecting, using the computer, an ad dollar weighting based on the simulation;
placing, using the computer, a plurality of advertisements using the ad dollar weighting on the internet advertising location;
receiving, at the computer, responses to polls based on the plurality of advertisements; and
repeating the simulating, selecting and placing as regular intervals while receiving until at least one sampling threshold for the poll is reached.

15. The method of claim 14, wherein there is an accuracy importance vector, the accuracy importance vector having values describing the relative importance of reaching a desired target for a demographic segment in the plurality of demographics being targeted.

16. The method of claim 15, wherein the selecting selects the ad dollar weighting having a sum of expectation less target squared weighted by the accuracy importance vector.

17. The method of claim 14,
wherein the internet advertising location does not permit targeting of ads directly on a first demographic segment in the plurality of demographics,
wherein each ad dollar weighting represents a potential ad spend across a plurality of permitted targets available at the internet advertising location, and
wherein for each of the permitted targets, the computer has a stored estimate of the likely expected number of recipients of the first demographic segments.

18. The method of claim 17, wherein the stored estimate of the likely expected number of recipients in of the first demographic segments is updated in response to the receiving of poll responses.

19. The method of claim 17, wherein the stored estimate is compared to the plurality of data about the demographic values during the selecting.

20. The method of claim 14, further comprising:
weighting, using the computer, the poll responses based on the plurality of data about demographic values; and
presenting, using the computer, results of the poll based on the poll responses and the weighting.
